(19) United States
(12) Patent Application Publication
(10) Pub. No.: US 2023/0367691 A1
(43) Pub. Date: Nov. 16, 2023

(54) METHOD AND APPARATUS FOR TESTING TARGET PROGRAM, DEVICE, AND STORAGE MEDIUM

(71) Applicant: Tencent Technology (Shenzhen) Company Limited, Shenzhen (CN)

(72) Inventors: Jiamin HUANG, Shenzhen (CN); Junhong Yan, Shenzhen (CN); Xusheng Ni, Shenzhen (CN); Canhui Huang, Shenzhen (CN)

(21) Appl. No.: 18/226,675

(22) Filed: Jul. 26, 2023

Related U.S. Application Data
(63) Continuation of application No. PCT/CN2022/124383, filed on Oct. 10, 2022.

(30) Foreign Application Priority Data
Nov. 26, 2021 (CN) 202111424326.3

(51) Int. Cl. G06F 11/34; G06F 9/455; G06F 11/36

(52) U.S. Cl. CPC G06F 11/3457; G06F 9/45529; G06F 11/3644

(57) ABSTRACT

A method for executing a target program is performed by a computer device. The method includes: displaying a user interface of a simulator, the user interface including a program page of the target program; enabling a barrier-free access mode of the target program in the simulator, in response to an enabling operation of the barrier-free access mode; and displaying information of barrier-free access on a page element in the program page of the target program in the barrier-free access mode. According to the present disclosure, the test for barrier-free access can be directly carried out on the simulator in a visual manner, with no need to run the target program on a real user terminal.

### CROSS-REFERENCE TO RELATED APPLICATIONS

This application is a continuation application of PCT Patent Application No. PCT/CN2022/124383, entitled “METHOD AND APPARATUS FOR TESTING TARGET PROGRAM, DEVICE, AND STORAGE MEDIUM” filed on Oct. 10, 2022, which claims priority to Chinese Patent Application No. 202111424326.3, entitled “METHOD AND APPARATUS FOR TESTING TARGET PROGRAM, DEVICE, AND STORAGE MEDIUM” filed with the Chinese Patent Office on Nov. 26, 2021, all of which is incorporated by reference in its entirety.

### FIELD OF THE TECHNOLOGY

Embodiments of the present disclosure relate to the field of software testing, and in particular, to a method and apparatus for executing a target program, a device, and a storage medium.

### BACKGROUND OF THE DISCLOSURE

Barrier-free design in Internet products mainly refers to the accessibility of the Internet products. The barrier-free design has the characteristic that allows the content of the Internet products to be recognized, understood, and interacted with by users directly or indirectly. For example, people who are blind can normally use touch-based application programs.

The development of a mini program is described as an example. A developer can preview the mini program on a real client through a preview function of a developer tool, and then test the barrier-free characteristic of each component in the mini program after enabling a barrier-free mode of the client. For example, the developer can enable a screen reading mode by selecting setting->general->accessibility->narration on the Apple operating system iOS. In this way, information carried in an accessible rich internet applications (ARIA) label will be read out after a certain component is focused.

The foregoing test method needs to be performed on a real terminal, which has cumbersome procedures, and relies on a reading function on the terminal, thereby reducing the test efficiency.

### SUMMARY

The present disclosure provides a method and apparatus of testing a target program, a device, and a storage medium. The technical solutions are as follows:

According to an aspect of the present disclosure, a method for executing a target program is provided. The method is performed by a computer device, and the method includes:
displaying a user interface of a simulator, the user interface including a program page of the target program;
enabling a barrier-free access mode of the target program in the simulator, in response to an enabling operation of the barrier-free access mode; and
displaying information of barrier-free access on a page element in the program page of the target program in the barrier-free access mode.

According to an aspect of the present disclosure, a computer device is provided. The computer device includes: a processor and a memory. The memory stores a computer program, and the computer program, when being executed by the processor, causes the computer device to implement the foregoing method for executing a target program.

According to another aspect of the present disclosure, a non-transitory computer-readable storage medium is provided. The computer-readable storage medium stores a computer program, and the computer program, when being executed by a processor, implements the foregoing method for executing a target program.

According to another aspect of the present disclosure, a computer program product is provided. The computer program product stores a computer program, and the computer program, when being executed by a processor, implements the foregoing method for executing a target program.

The technical solutions provided by the embodiments of the present disclosure have at least the following beneficial effects:

The barrier-free access mode is added in the simulator. In the barrier-free access mode, the design information related to the barrier-free access is displayed on the user interface of the simulator as visual information, so that the test for the barrier-free access can be directly carried out on the simulator in a visual manner. There is no need to run the target program on a real user terminal, which reduces the test steps, thereby improving the test efficiency.

### BRIEF DESCRIPTION OF THE DRAWINGS

FIG. 1 shows a structural block diagram of a computer system according to an exemplary embodiment of the present disclosure.

FIG. 2 shows a schematic structural diagram of a host program and a mini program according to an exemplary embodiment of the present disclosure.

FIG. 3 shows a flowchart of a method for executing a target program according to an exemplary embodiment of the present disclosure.

FIG. 4 shows a schematic diagram of an interface of a barrier-free access mode according to an exemplary embodiment of the present disclosure.

FIG. 5 shows a flowchart of a method for executing a target program according to an exemplary embodiment of the present disclosure.

FIG. 6 shows a schematic diagram of an interface of a barrier-free access mode according to an exemplary embodiment of the present disclosure.

FIG. 7 shows a schematic diagram of an interface of a barrier-free access mode according to an exemplary embodiment of the present disclosure.

FIG. 8 shows a schematic diagram of an interface of a barrier-free access mode according to an exemplary embodiment of the present disclosure.

FIG. 9 shows a schematic diagram of an interface of a barrier-free access mode according to an exemplary embodiment of the present disclosure.

FIG. 10 shows a schematic diagram of an interface of a barrier-free access mode according to an exemplary embodiment of the present disclosure.

FIG. 11 shows a schematic diagram of an interface of a barrier-free access mode according to an exemplary embodiment of the present disclosure.

FIG. 12 shows a schematic diagram of an interface of a barrier-free access mode according to an exemplary embodiment of the present disclosure.

FIG. 13 shows a schematic diagram of an interface of a barrier-free access mode according to an exemplary embodiment of the present disclosure.

FIG. 14 shows a schematic diagram of an interface of a barrier-free access mode according to an exemplary embodiment of the present disclosure.

FIG. 15 shows a schematic diagram of an interface of a barrier-free access mode according to an exemplary embodiment of the present disclosure.

FIG. 16 shows a flowchart of a method for executing a target program according to an exemplary embodiment of the present disclosure.

FIG. 17 shows a schematic diagram of script insertion of a barrier-free access mode plug-in according to an exemplary embodiment of the present disclosure.

FIG. 18 shows a sequence diagram of a method for executing a target program according to an exemplary embodiment of the present disclosure.

FIG. 19 shows a block diagram of an apparatus for executing a target program according to an exemplary embodiment of the present disclosure.

FIG. 20 shows a block diagram of a computer device according to an exemplary embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

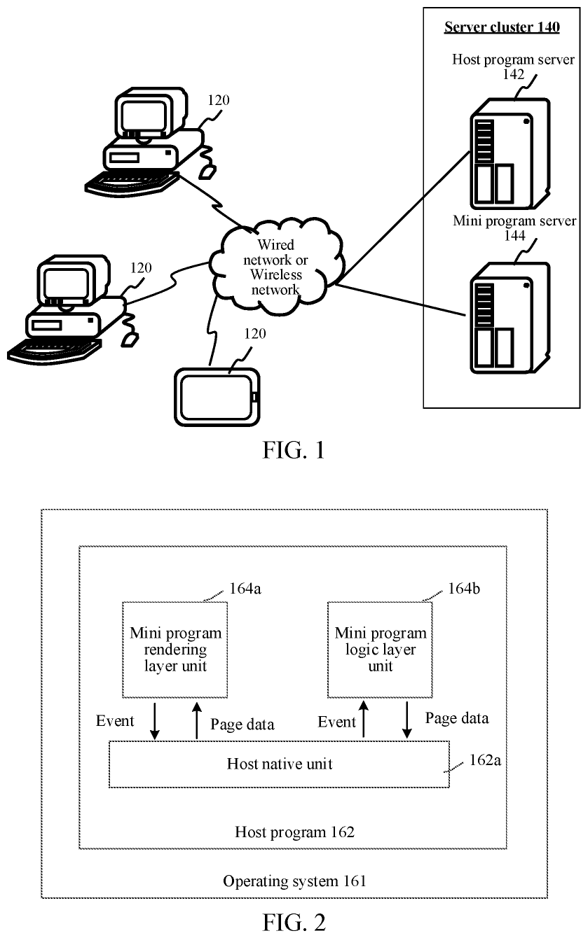

FIG. 1 shows a structural block diagram of a computer system 100 according to an exemplary embodiment of the present disclosure. The computer system 100 includes: a terminal 120 and a server cluster 140. The “terminal device” mentioned in the embodiments of the present disclosure may be called a “terminal”.

The terminal 120 may be a mobile phone, a tablet computer, an e-book reader, a Moving Picture Experts Group Audio Layer III (MP3) player, a Moving Picture Experts Group Audio Layer IV (MP4) player, a laptop computer, a desktop computer, or the like. The terminal 120 is configured to develop, compile, and test a target program. The target program is an application program developed based on hypertext markup language (HTML). Illustratively, the target program includes: a web application and a mini program. The web application is the application that runs in a traditional browser, and the mini program is the application that runs depending on a runtime environment provided by a host program. The host program provides a web-class runtime environment for the mini program, so that the mini program is loaded and run in the runtime environment provided by the host program. In some embodiments, A simulator of the target program runs on the terminal 120, and the simulator is configured to simulate the runtime environment for the target program.

The terminal 120 is connected to the server cluster 140 through a wired network or a wireless network.

The server cluster 140 may be any one of a plurality of servers, a virtual cloud storage, or a cloud computing center. The server cluster 140 is configured to provide background services for a predetermined application program on the terminal 120, a host program and a mini program on the terminal 120. The server cluster 140 has a data storage capacity. In some embodiments, the server cluster 140 includes: a host program server 142 and a mini program server 144.

The host program server 142 is configured to provide the background service for the host program in the terminal 120.

The mini program server 144 is configured to provide the background service for the mini program in the terminal 120.

The embodiments are described by using an example in which the server 140 includes two servers. However, the server cluster 140 may include more than or less than two servers. For example, the server cluster 140 is implemented by a plurality of virtual machines on one server, or is implemented by dozens of servers, which is not limited in the embodiments.

In an exemplary example, the terminal 120 includes an operating system 161, a host program 162, and a mini program. Referring to FIG. 2, the operating system 161 runs on the terminal 120, and the host program 162 is run in the operating system 161. The host program 162 provides a runtime environment for the mini program. The terminal 120 may create a mini program logic layer unit 164b for realizing the mini program and a corresponding mini program rendering layer unit 164a, according to a package of the mini program. The mini program logic layer unit 164b may be configured to execute a page logic code in the package, and the mini program rendering layer unit 164a may be configured to execute a page structure code in the package, and also execute a page style code in the package. The page logic code, the page structure code, and the page style code in the package may be collectively referred to as a page code.

The operating system 161 is a computer program managing and controlling hardware and software resources in the terminal 120, and is most basic system software directly running on the bare terminal 120. The application program needs to be run under the support of the operating system 161. The operating system 161 may be a desktop operating system, such as the Windows operating system, the Linux operating system, or the Mac operating system (Apple desktop operating system), or may be a mobile operating system, such as the iOS (Apple mobile terminal operating system) or the Android operating system.

The host program 162 is an application program that carries the mini program, and provides an environment for implementing the mini program. The host program 162 is a native application program. The native application program is an application program that may be directly run on the operating system 161. The host program 162 may be a social application program, a dedicated application program specially supporting the mini program, a file management application program, an email application program, a game application program, or the like. The social application program includes an instant messaging application, a social network service (SNS) application, a live broadcast application, or the like. The mini program is the application program that may be run in the environment provided by the host program. The mini program may be specifically a social application program, a file management application program, a mail application program, a game application program, or the like.

The mini program logic layer unit 164b and the corresponding mini program rendering layer (also called view layer) unit 164a are configured to implement an instance of a mini program. One mini program may be implemented by one mini program logic layer unit 164b and at least one mini program rendering layer unit 164a. The mini program rendering layer units 164a may have one-to-one match with mini program pages.

The mini program rendering layer unit 164a is configured to organize and render the view of the mini program. The mini program logic layer unit 164b is configured to process data processing logic of the mini program and the corresponding mini program page. The unit may be specifically a process or a thread. For example, the mini program rendering layer unit 164a is a mini program rendering layer thread, and the mini program logic layer unit 164b is a mini program logic layer thread. The mini program logic layer unit 164b may be run in a virtual machine. The mini program rendering layer unit 164a and the mini program logic layer unit 164b may transfer communication through a host program native unit 162a. The host program native unit 162a is an interface for communication between the host program 162 and the mini program. The host program native unit 162a may be a thread or a process of the host program 162. The page logic code of each mini program page that belongs to the package may be registered when the mini program logic layer unit 164b is started, and the registered page logic code is executed when the page logic code is needed to process data.

In some embodiments, in a development environment, the host program may be replaced by a developer tool, such as a compiler, a simulator, or the like. The developer tool provides the runtime environment for the target program.

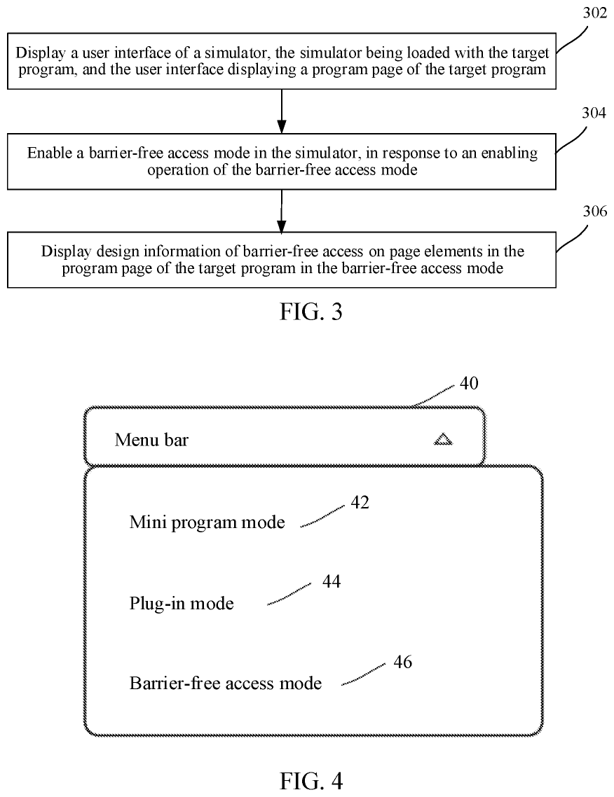

FIG. 3 shows a flowchart of a method for executing a target program according to an exemplary embodiment of the present disclosure. The method may be applied in a terminal, or the method may be executed by a terminal. The method may include at least one of the following step 302 to step 306:

Step 302: Display a user interface of a simulator. The simulator is loaded with the target program, and the user interface displays a program page of the target program.

The simulator is a program tool configured to simulate running the target program. Exemplarily, the simulator is a separate program, or the simulator is a function in a developer tool.

Illustratively, the developer tool provides functions such as simulator, editor, debugger, visualization, and cloud development. A developer starts the simulator in the developer tool, and uses the simulator to load the target program.

The terminal displays the user interface of the simulator, the simulator is loaded with the target program, and the user interface displays the program page of the target program. Illustratively, the program page is obtained through rendering based on a rendering layer code of the target program.

Step 304: Enable a barrier-free access mode in the simulator, in response to an enabling operation of the barrier-free access mode.

The simulator is provided with the barrier-free access mode, which is the mode for simulating that an operating system runs the target program after the barrier-free access mode is enabled. The barrier-free access mode may also be called a barrier-free mode or a barrier-free debugging mode.

The user interface of the simulator displays a trigger entry of the barrier-free access mode. The trigger entry is a menu bar, a function button, a hand gesture trigger entry, or the like. Referring to FIG. 4, a menu bar 40 is provided on the user interface of the simulator. A mini program mode 42, a plug-in mode 44, and a barrier-free access mode 46 are displayed in menu items of the menu bar 40.

The enabling operation includes but is not limited to: a single click operation, a double click operation, a slide operation, a hand gesture operation, a motion sensing operation, a pressure touch operation, and a binocular gaze operation.

Illustratively, the barrier-free access mode is enabled in the simulator after a user clicks the barrier-free access mode 46.

Step 306: Display design information of barrier-free access on a page element in the program page of the target program in the barrier-free access mode.

Illustratively, the design information of the barrier-free access includes: operable area information of the barrier-free access and audio information of the barrier-free access.

The operable area information of the barrier-free access is configured for indicating an operating area on the program page corresponding to each page element that can respond to a human-machine interaction operation in the barrier-free access mode.

The audio information of the barrier-free access is configured for indicating voice information that is triggered to read out in response to the page element receiving the human-machine interaction operation in the barrier-free access mode.

In summary, according to the method provided by the embodiments, the barrier-free access mode is added in the simulator. In the barrier-free access mode, the design information related to the barrier-free access is displayed on the user interface of the simulator as visual information, so that the test for the barrier-free access can be directly carried out on the simulator in a visual manner. There is no need to run the target program on a real user terminal, which reduces the test steps, thereby improving the test efficiency.

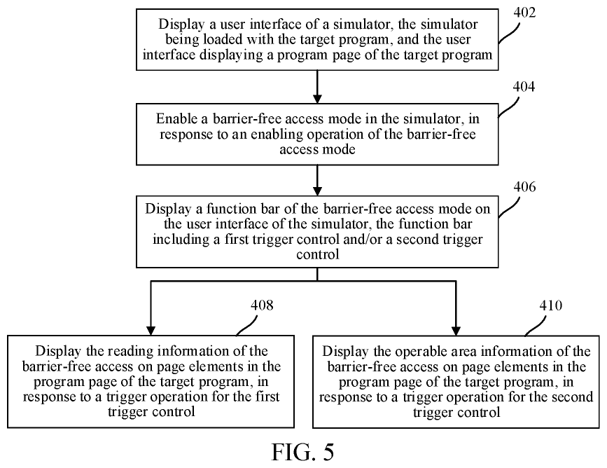

FIG. 5 shows a flowchart of a method for executing a target program according to an exemplary embodiment of the present disclosure. The method may be applied in a terminal, or the method may be executed by a terminal. The method may include at least one of the following step 402 to step 410:

Step 402: Display a user interface of a simulator. The simulator is loaded with the target program, and the user interface displays a program page of the target program.

The simulator is a program tool configured to simulate running the target program. Exemplarily, the simulator is a separate program, or the simulator is a function in a developer tool.

Illustratively, the developer tool provides functions such as simulator, editor, debugger, visualization, and cloud development. A developer starts the simulator in the developer tool, and uses the simulator to load the target program.

The terminal displays the user interface of the simulator, the simulator is loaded with the target program, and the user interface displays the program page of the target program. Illustratively, the program page is obtained through rendering based on a rendering layer code of the target program.

Step 404: Enable a barrier-free access mode in the simulator, in response to an enabling operation of the barrier-free access mode.

The simulator is provided with the barrier-free access mode, which is the mode for simulating that an operating system runs the target program after the barrier-free access mode is enabled. The barrier-free access mode may also be called a barrier-free mode or a barrier-free debugging mode.

The user interface of the simulator displays a trigger entry of the barrier-free access mode. The trigger entry is a menu bar, a function button, a hand gesture trigger entry, or the like. Referring to FIG. 4, a menu bar 40 is provided on the user interface of the simulator. A mini program mode 42, a plug-in mode 44, and a barrier-free access mode 46 are displayed in menu items of the menu bar 40.

The enabling operation includes but is not limited to: a single click operation, a double click operation, a slide operation, a hand gesture operation, a motion sensing operation, a pressure touch operation, and a binocular gaze operation.

Illustratively, the barrier-free access mode is enabled in the simulator after a user clicks the barrier-free access mode 46.

Step 406: Display a function bar of the barrier-free access mode on the user interface of the simulator. The function bar includes a first trigger control and/or a second trigger control.

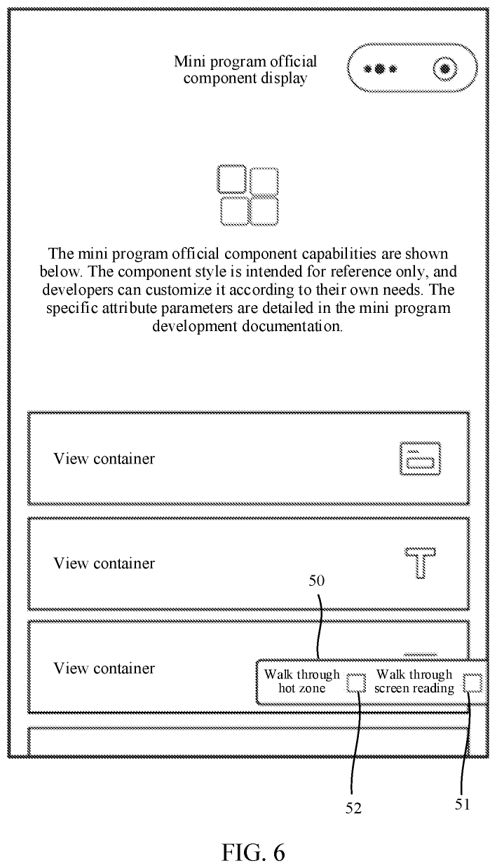

As shown in FIG. 6, after the barrier-free access mode is enabled, a function bar 50 of the barrier-free access mode is additionally displayed on the user interface of the simulator. A first trigger control 51 and/or a second trigger control 52 are displayed on the function bar 50.

The first trigger control 51 is the control configured to trigger display of the audio information of the barrier-free access. The second trigger control 52 is the control configured to trigger display of the operable area information of the barrier-free access.

The control type of the first trigger control 51 and the second trigger control 52 may be a button, a check box, a menu bar, or the like. Since the audio information of the barrier-free access is commonly known as screen reading, the first trigger control 51 may be a “walk through screen reading” 51, and the second trigger control 52 may be a “walk through hot zone” button 52.

In some embodiments, the function bar further includes a third trigger control. The third trigger control is the control configured to trigger display of the audio information of the barrier-free access and trigger display of the operable area information of the barrier-free access.

Step 408: Display the audio information of the barrier-free access on a page element in the program page of the target program, in response to a trigger operation for the first trigger control.

In some embodiments, the audio information of the barrier-free access is displayed on the page element in the program page of the target program, in response to the trigger operation on the first trigger control.

The trigger operation includes but is not limited to: a single click operation, a double click operation, a slide operation, a hand gesture operation, a motion sensing operation, a pressure touch operation, and a binocular gaze operation.

The program page of the target program includes a plurality of page elements (which may be understood as first page elements) with the audio information. After all or part of the page elements are triggered (for example, clicked), the audio information of the barrier-free access is read.

In the test mode of the barrier-free access, since the audio information of the barrier-free access is generally text, the audio information is displayed on the page elements in the form of text. On one hand, the audio information of the plurality of page elements can be displayed at the same time, with no need to click the page elements one by one; on the other hand, it is more intuitive to display in the form of visual text, which significantly improves the test efficiency.

Illustratively, in response to the trigger operation for the first trigger control, a first annotation box is displayed on each page element in the program page of the target program, and the audio information of the page element is displayed on the first annotation box. For the page elements with the audio information, each page element corresponds to the respective first annotation box, that is, the page elements with the audio information are in one-to-one match with the first annotation boxes.

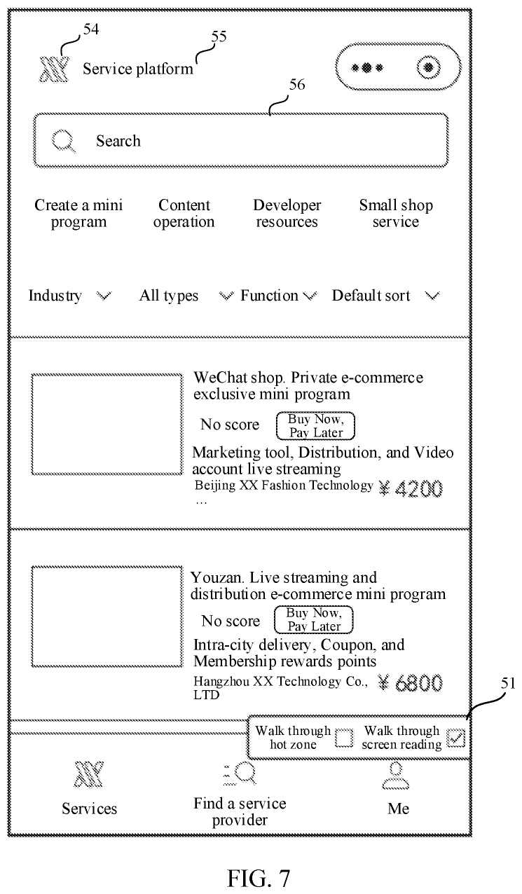

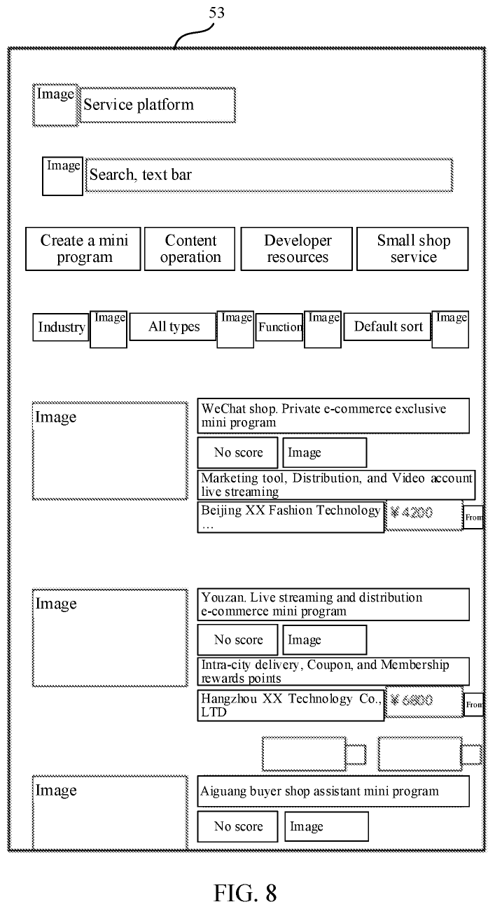

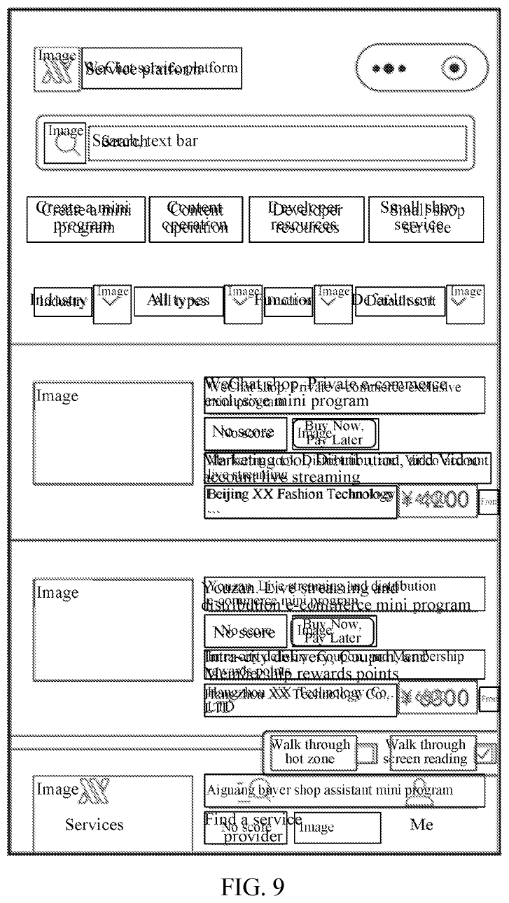

As shown in FIG. 7, FIG. 8, and FIG. 9 (FIG. 9 is obtained by performing floating-layer overlay on FIG. 7 and FIG. 8), after the “walk through screen reading” control 51 is checked, the audio information 53 of the barrier-free access of each page element is additionally displayed on the program page. Illustratively, the first annotation box is added on each page element, and the audio information of the current page element is displayed in the first annotation box. For example, the audio information corresponding to the page element 54 is “image”; for another example, the audio information corresponding to the page element “service platform” 55 is “service platform”; for still another example, the audio information corresponding to the page element “search box” 56 is “search, text bar”. The other examples are not detailed herein.

In some embodiments, a length and a width of the first annotation box are related to a size of the current page element. For example, the length and the width of the first annotation box are equal to or slightly smaller than a length and a width of the current page element. In some embodiments, a display style of the first annotation box is not limited in the present disclosure. For example, in the case of displaying the first annotation box, the page element located under the first annotation box may be covered, and the first annotation box is opaque or translucent.

In some embodiments, in response to a check operation for the first annotation box, the length and the width of the first annotation box and/or the display style of the first annotation box are changed. The check operation includes but is not limited to: a touch operation, a click operation, and a hover touch operation.

In an example, the first annotation box is in the translucent form by default. In the case that a signal, such as a touch signal, a click signal, or a hover touch signal, is sensed on the first annotation box, the first annotation box is switched to the opaque form. And/or, the first annotation box is in a form of a first length and width by default. In the case that a signal, such as a touch signal, a click signal, or a hover touch signal, is sensed on the first annotation box, the first annotation box is switched to a form of a second length and width. The second length and width are greater than the first length and width.

Step 410: Display the operable area information of the barrier-free access on a page element in the program page of the target program, in response to a trigger operation for the second trigger control.

In some embodiments, in response to the trigger operation on the second trigger control, the operable area information of the barrier-free access is displayed on the page element in the program page of the target program.

The trigger operation includes but is not limited to: a single click operation, a double click operation, a slide operation, a hand gesture operation, a motion sensing operation, a pressure touch operation, and a binocular gaze operation.

The program page of the target program includes a plurality of page elements (which may be understood as second page elements) that support human-machine interaction operations. After all or part of the page elements are triggered (for example, clicked), the operable area information of the barrier-free access is displayed. On the same program page, the first page elements and the second page elements are not necessarily the same, instead, they may be different.

In the test mode of the barrier-free access, since the operable area information of the barrier-free access is generally text, the operable area information is displayed on the page elements in the form of text. On one hand, the operable area information of the plurality of page elements can be displayed at the same time, with no need to click the page elements one by one; on the other hand, it is more intuitive to display in the form of visual text, which significantly improves the test efficiency.

Illustratively, in response to the trigger operation for the second trigger control, a second annotation box is displayed on each page element in the program page of the target program, and the operable area information of the page element is displayed on the second annotation box. For the page elements with the operable area information, each page element corresponds to the respective second annotation box, that is, the page elements with the operable area information are in one-to-one match with the second annotation boxes.

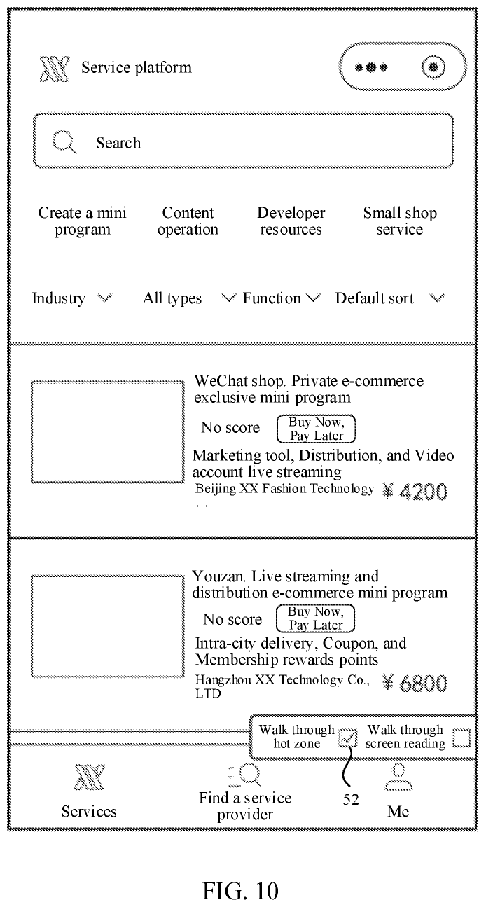

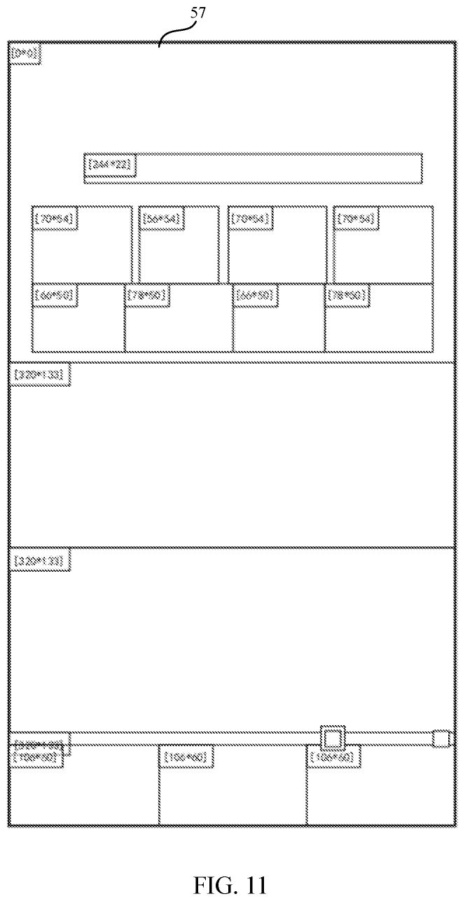

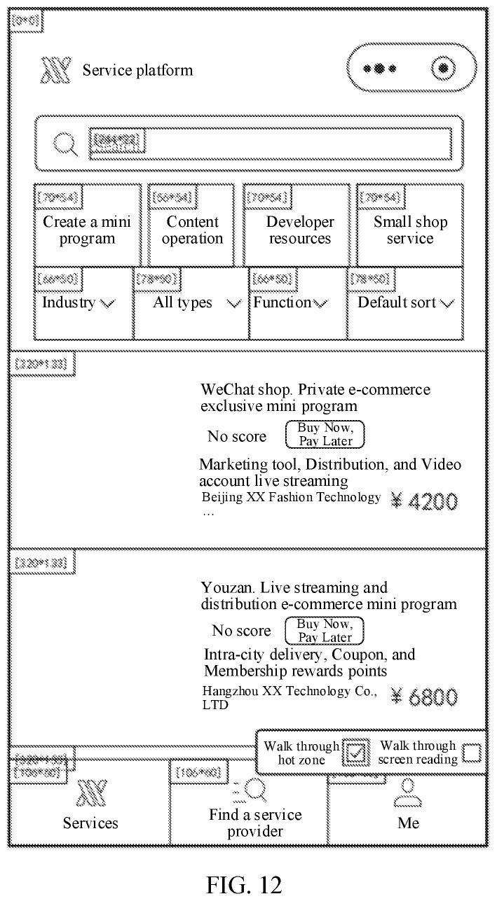

As shown in FIG. 10, FIG. 11, and FIG. 12 (FIG. 12 is obtained by performing floating-layer overlay on FIG. 10 and FIG. 11), after the “walk through hot zone” button 52 is checked, the operable area information 57 of the barrier-free access of all or part of the page elements is additionally displayed on the program page. Illustratively, the second annotation box is added on each page element, and the operable area information of the current page element is displayed in the second annotation box. The operable area information is represented by “length*width”.

In some embodiments, a length and a width of the second annotation box are related to a size of the current page element. For example, the length and the width of the second annotation box are equal to or slightly smaller than or slightly greater than a length and a width of the current page element. In some embodiments, a display style of the second annotation box is not limited in the present disclosure. For example, in the case of displaying the second annotation box, the page element located under the second annotation box may be covered, and the second annotation box is opaque or translucent.

In some embodiments, in response to a check operation for the second annotation box, the length and the width of the second annotation box and/or the display style of the second annotation box are changed. The check operation includes but is not limited to: a touch operation, a click operation, and a hover touch operation.

In an example, the second annotation box is in the translucent form by default. In the case that a signal, such as a touch signal, a click signal, or a hover touch signal, is sensed on the second annotation box, the second annotation box is switched to the opaque form. And/or, the second annotation box is in a form of a first length and width by default. In the case that a signal, such as a touch signal, a click signal, or a hover touch signal, is sensed on the second annotation box, the second annotation box is switched to a form of a second length and width. The second length and width are greater than the first length and width.

In some embodiments, in response to a trigger operation for the first trigger control and the second trigger control, a mixed annotation box is displayed on each page element in the program page of the target program. The audio information and the operable area information of the current page element are displayed on the mixed annotation box. The mixed annotation box may be formed by superimposing the first annotation box and the second annotation box, or may be formed by combining the first annotation box and the second annotation box.

As shown in FIG. 9, after the “walk through hot zone” button and the “walk through screen reading” button on the function bar 50 are both checked, the operable area information and the screen audio information 58 of the barrier-free access of all or part of the page elements are additionally displayed on the program page. Illustratively, the mixed annotation box is added on each page element, and the operable area information and the audio information of the current page element are displayed in the mixed annotation box.

In some embodiments, in response to the trigger operation for the third trigger control, the mixed annotation box is displayed on each page element in the program page of the target program, and the audio information and the operable area information of the current page element are displayed on the mixed annotation box. The mixed annotation box may be formed by superimposing the first annotation box and the second annotation box, or may be formed by combining the first annotation box and the second annotation box.

By the first trigger control, the second trigger control or the third trigger control, the functions of “walk through screen reading” and/or “walk through hot zone” are respectively realized, thereby realizing classification test for the functions provided by the barrier-free access mode in the visual manner.

In summary, according to the method provided by the embodiments, the barrier-free access mode is added in the simulator. In the barrier-free access mode, the design information related to the barrier-free access is displayed on the user interface of the simulator as visual information, so that the test for the barrier-free access can be directly carried out on the simulator in a visual manner. There is no need to run the target program on a real user terminal, which reduces the test steps, thereby improving the test efficiency.

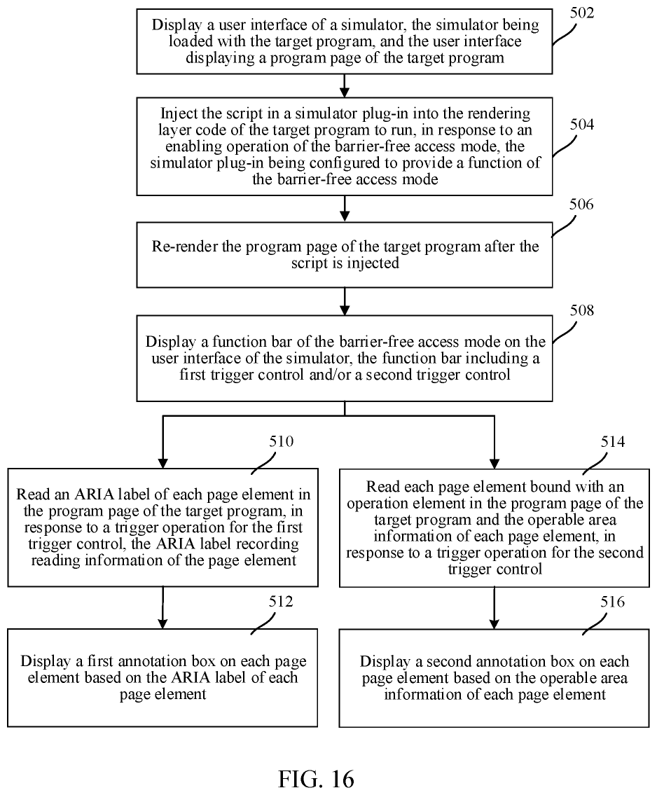

FIG. 16 shows a flowchart of a method for executing a target program according to an exemplary embodiment of the present disclosure. The method may be applied in a terminal, or the method may be executed by a terminal. The method may include at least one of the following step 502 to step 516:

Step 502: Display a user interface of a simulator. The simulator is loaded with the target program, and the user interface displays a program page of the target program.

The simulator is a program tool configured to simulate running the target program. Exemplarily, the simulator is a separate program, or the simulator is a function in a developer tool.

Illustratively, the developer tool provides functions such as simulator, editor, debugger, visualization, and cloud development. A developer starts the simulator in the developer tool, and uses the simulator to load the target program.

The terminal displays the user interface of the simulator, the simulator is loaded with the target program, and the user interface displays the program page of the target program. Illustratively, the program page is obtained through rendering based on a rendering layer code of the target program.

Step 504: Inject a script in a simulator plug-in into the rendering layer code of the target program to run, in response to an enabling operation of the barrier-free access mode. The simulator plug-in is configured to provide a function of the barrier-free access mode.

The simulator is provided with the barrier-free access mode, which is the mode for simulating that an operating system runs the target program after the barrier-free access mode is enabled. The barrier-free access mode may also be called a barrier-free mode or a barrier-free debugging mode.

The user interface of the simulator displays a trigger entry of the barrier-free access mode. The trigger entry is a menu bar, a function button, a hand gesture trigger entry, or the like. Referring to FIG. 4, a menu bar 40 is provided on the user interface of the simulator. A mini program mode 42, a plug-in mode 44, and a barrier-free access mode 46 are displayed in menu items of the menu bar 40.

The enabling operation includes but is not limited to: a single click operation, a double click operation, a slide operation, a hand gesture operation, a motion sensing operation, a pressure touch operation, and a binocular gaze operation.

Illustratively, the barrier-free access mode is enabled in the simulator after a user clicks the barrier-free access mode 46.

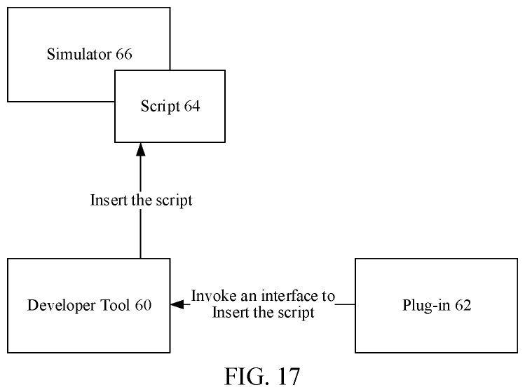

Referring to FIG. 17, the barrier-free access mode is implemented by a plug-in 62 in the developer tool 60. After the user clicks the barrier-free access mode, the developer tool 60 reads a plug-in code of the plug-in 62 for execution. The plug-in has a built-in script 64, which is injected into the rendering layer code of the target program running in the simulator 66 through a program interface of the developer tool, so as to execute the function of the barrier-free access mode provided by the plug-in.

Step 506: Re-render the program page of the target program after the script is injected.

The script is also run during the process of re-rendering the program page of the target program. The script provides the function bar of the barrier-free access mode.

Step 508: Display a function bar of the barrier-free access mode on the user interface of the simulator. The function bar includes a first trigger control and/or a second trigger control.

As shown in FIG. 6, after the barrier-free access mode is enabled, a function bar 50 of the barrier-free access mode is additionally displayed on the user interface of the simulator. A first trigger control 51 and/or a second trigger control 52 are displayed on the function bar 50.

The first trigger control 51 is the control configured to trigger display of the audio information of the barrier-free access. The second trigger control 52 is the control configured to trigger display of the operable area information of the barrier-free access.

The control type of the first trigger control 51 and the second trigger control 52 may be a button, a check box, a menu bar, or the like. Since the audio information of the barrier-free access is commonly known as screen reading, the first trigger control 51 may be a “walk through screen reading” 51, and the second trigger control 52 may be a “walk through hot zone” button 52.

In some embodiments, the function bar further includes a third trigger control. The third trigger control is the control configured to trigger display of the audio information of the barrier-free access and trigger display of the operable area information of the barrier-free access.

Step 510: Read an ARIA label of each page element in the program page of the target program, in response to a trigger operation for the first trigger control. The ARIA label records audio information of the page element.

In some embodiments, the ARIA label of each page element in the program page of the target program is read, in response to the trigger operation on the first trigger control. The ARIA label records the audio information of the page element.

The trigger operation includes but is not limited to: a single click operation, a double click operation, a slide operation, a hand gesture operation, a motion sensing operation, a pressure touch operation, and a binocular gaze operation.

The program page of the target program includes a plurality of page elements. After all or part of the page elements are triggered (for example, clicked), the audio information of the barrier-free access is read.

All or part of the page elements are bound with the ARIA labels, which record the audio information of the page elements.

Step 512: Display a first annotation box on each page element based on the ARIA label of each page element.

For the page elements with the ARIA labels, the first annotation box of each page element is generated based on the ARIA label of each page element.

Illustratively, in response to the trigger operation for the first trigger control, a first annotation box is displayed on each page element in the program page of the target program, and the audio information of the page element is displayed on the first annotation box. For the page elements with the audio information, each page element corresponds to the respective first annotation box, that is, the page elements with the audio information are in one-to-one match with the first annotation boxes.

As shown in FIG. 7, FIG. 8, and FIG. 9 (FIG. 9 is obtained by performing floating-layer overlay on FIG. 7 and FIG. 8), after the “walk through screen reading” control 51 is checked, the audio information 53 of the barrier-free access of each page element is additionally displayed on the program page. Illustratively, the first annotation box is added on each page element, and the audio information of the current page element is displayed in the first annotation box. For example, the audio information corresponding to the page element 54 is “image”; for another example, the audio information corresponding to the page element “service platform” 55 is “service platform”; for still another example, the audio information corresponding to the page element “search box” 56 is “search, text bar”. The other examples are not detailed herein.

In some embodiments, a length and a width of the first annotation box are related to a size of the current page element. For example, the length and the width of the first annotation box are equal to or slightly smaller than a length and a width of the current page element. In the case of displaying the first annotation box, the page element located under the first annotation box may be covered, and the first annotation box is opaque or translucent.

In an example, the first annotation box is in the translucent form by default. In the case that a signal, such as a touch signal, a click signal, or a hover touch signal, is sensed on the first annotation box, the first annotation box is switched to the opaque form. And/or, the first annotation box is in a form of a first length and width by default. In the case that a signal, such as a touch signal, a click signal, or a hover touch signal, is sensed on the first annotation box, the first annotation box is switched to a form of a second length and width. The second length and width are greater than the first length and width.

Based on the ARIA label of each page element, the first annotation box is displayed on each page element, which ensures the display accuracy of the first annotation box.

Step 514: Read each page element bound with an operation element in the program page of the target program and the operable area information of each page element, in response to a trigger operation for the second trigger control.

In some embodiments, each page element bound with the operation element in the program page of the target program and the operable area information of each page element are read, in response to the trigger operation on the second trigger control.

The trigger operation includes but is not limited to: a single click operation, a double click operation, a slide operation, a hand gesture operation, a motion sensing operation, a pressure touch operation, and a binocular gaze operation.

The program page of the target program includes a plurality of page elements. After all or part of the page elements are triggered (for example, clicked), the operable area information of the barrier-free access is displayed.

Step 516: Display a second annotation box on each page element based on the operable area information of each page element.

In the test mode of the barrier-free access, since the operable area information of the barrier-free access is generally text, the operable area information is displayed on the page elements in the form of text. On one hand, the operable area information of the plurality of page elements can be displayed at the same time, with no need to click the page elements one by one; on the other hand, it is more intuitive to display in the form of visual text, which significantly improves the test efficiency.

Illustratively, in response to the trigger operation for the second trigger control, a second annotation box is displayed on each page element in the program page of the target program, and the operable area information of the page element is displayed on the second annotation box. For the page elements with the operable area information, each page element corresponds to the respective second annotation box, that is, the page elements with the operable area information are in one-to-one match with the second annotation boxes.

As shown in FIG. 10, FIG. 11, and FIG. 12 (FIG. 12 is obtained by performing floating-layer overlay on FIG. 10 and FIG. 11), after the “walk through hot zone” button 52 is checked, the operable area information 57 of the barrier-free access of all or part of the page elements is additionally displayed on the program page. Illustratively, the second annotation box is added on each page element, and the operable area information of the current page element is displayed in the second annotation box. The operable area information is represented by “length*width”.

In some embodiments, a length and a width of the second annotation box are related to a size of the current page element. For example, the length and the width of the second annotation box are equal to or slightly smaller than or slightly greater than a length and a width of the current page element. In the case of displaying the second annotation box, the page element located under the second annotation box may be covered, and the second annotation box is opaque or translucent.

In an example, the second annotation box is in the translucent form by default. In the case that a signal, such as a touch signal, a click signal, or a hover touch signal, is sensed on the second annotation box, the second annotation box is switched to the opaque form. And/or, the second annotation box is in a form of a first length and width by default. In the case that a signal, such as a touch signal, a click signal, or a hover touch signal, is sensed on the second annotation box, the second annotation box is switched to a form of a second length and width. The second length and width are greater than the first length and width.

Based on the operable area information of each page element, the second annotation box is displayed on each page element, which ensures the display accuracy of the second annotation box.

In some embodiments, in response to a trigger operation for the first trigger control and the second trigger control, a mixed annotation box is displayed on each page element in the program page of the target program. The audio information and the operable area information of the current page element are displayed on the mixed annotation box.

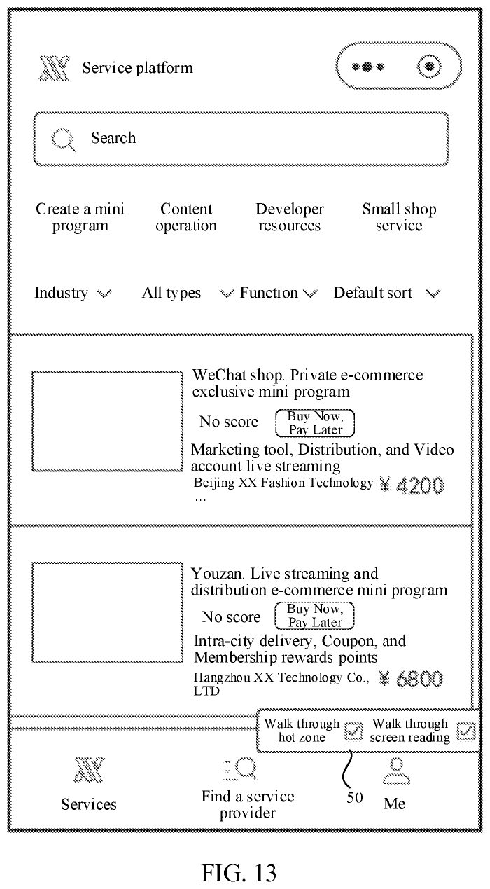

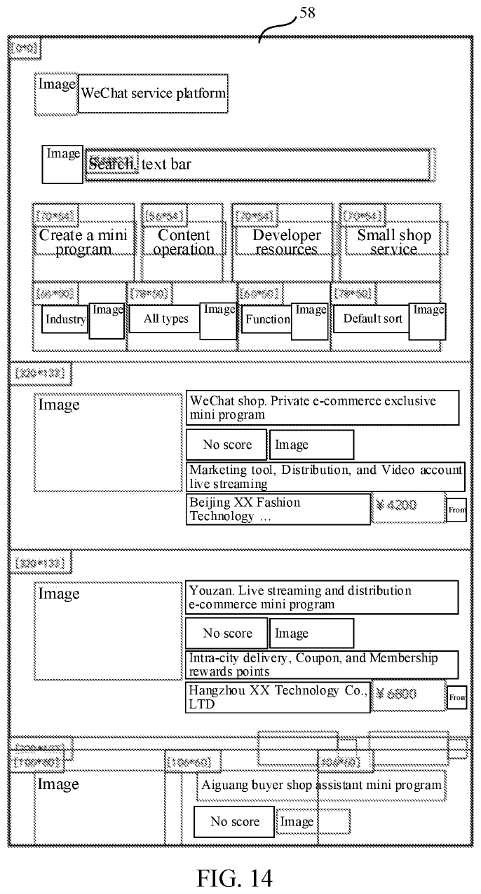

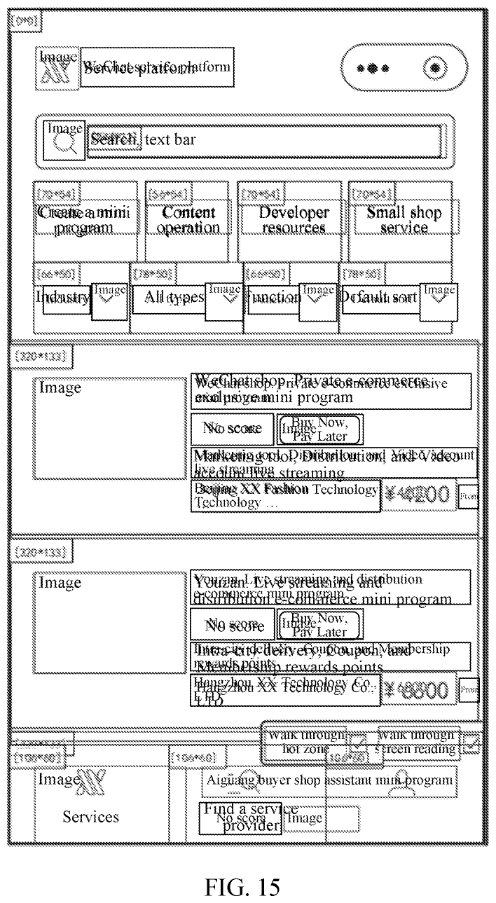

As shown in FIG. 13, FIG. 14, and FIG. 15 (FIG. 15 is obtained by performing floating-layer overlay on FIG. 13 and FIG. 14), after the “walk through hot zone” button and the “walk through screen reading” button on the function bar 50 are both checked, the operable area information and the screen audio information 58 of the barrier-free access of all or part of the page elements are additionally displayed on the program page. Illustratively, the mixed annotation box is added on each page element, and the operable area information and the audio information of the current page element are displayed in the mixed annotation box.

In some embodiments, in response to the trigger operation for the third trigger control, the mixed annotation box is displayed on each page element in the program page of the target program, and the audio information and the operable area information of the current page element are displayed on the mixed annotation box.

In summary, according to the method provided by the embodiments, the barrier-free access mode is added in the simulator. In the barrier-free access mode, the design information related to the barrier-free access is displayed on the user interface of the simulator as visual information, so that the test for the barrier-free access can be directly carried out on the simulator in a visual manner. There is no need to run the target program on a real user terminal, which reduces the test steps, thereby improving the test efficiency.

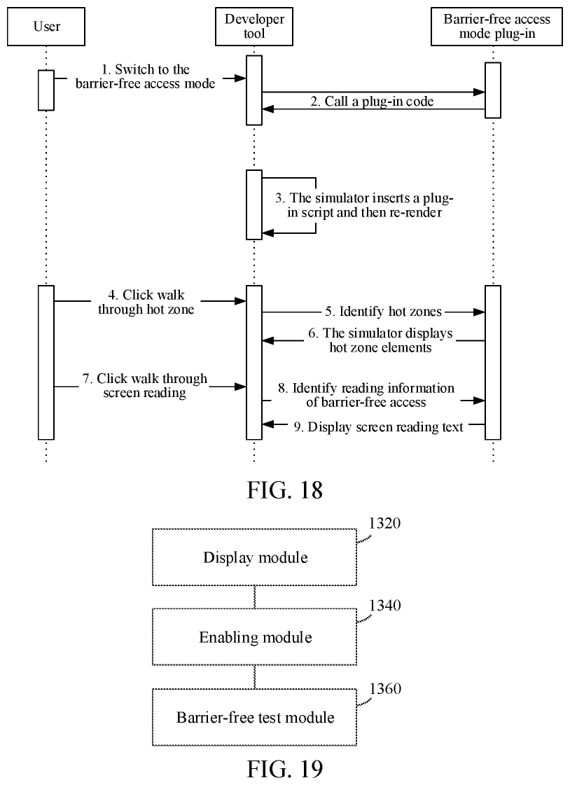

In an example, referring to FIG. 18, 1. A user switches to the barrier-free access mode on a developer tool; 2. The developer tool invokes a barrier-free access mode plug-in, and calls a plug-in code to run; 3. A simulator in the developer tool inserts a plug-in script to a rendering layer of a mini program, and the simulator first obtains a page structure of the rendering layer of the mini program, inserts an additional script page element into the page structure of the rendering layer, where the script page element displaying “walk through hot zone” and “walk through screen reading”, and then binds the selection event logic of the walk through hot zone and the walk through screen reading respectively. 4. The user clicks “walk through hot zone”; 5. The script traverses all the page elements of the rendering layer, to identify the hot zones and find operable page elements (input boxes, page elements bound to click event), and obtains the widths and heights of these page elements; 6. The script generates additional blue boxes to display the hot zone page elements; 7. The user clicks “walk through screen reading”; 8. The script traverses all the page elements of the rendering layer, to identify the audio information of the barrier-free access; 9. The script reads the properties (for example, names of the page element components) of the page elements and the additional information carried by in the ARIA labels, and finally generates additional red boxes to annotate the content of the screen reading.

A simple page with only one button is described as an example. This button is bound to a click event, and the code is as follows:
<button bindtap=“clickMe”>Click me</button>

The script will obtain actual rendering information of this button as follows:
<wx-button exparser:info-class-prefix=“ ” exparser:info-component-id=“3” exparser:info-attr-bindtap=“clickMe” role=“button” aria-disabled=“false” wx:nodeid=“9”>Click me</wx-button>

After the user selects the “walk through hot zone”, the script will traverse to this button structure. It is found that the attribute contains “exparser:info-attr-bindtap”, which indicates that this button is bound to an event, and is an operable page element rather than pure display content. Accordingly, the script obtains the style (the width, height, and position information) of this page element, and generates a blue box of the same width and height at the same position to box this page element up, and displays the width and height of this page element in the upper left corner.

After the user s selects “walk through screen reading”, similarly, the script will traverse to this page element. It is found that this page element is a button label with a corresponding semantics of “button”. The text of this button is “click me”, so the content read out is “click me, button”. The script records the screen reading content of this page element, and obtains the width, height, and position information of this page element. Similarly, a red box with the same width and height as this button is generated at the same position to box this button up, and the text content “Click me, button” of the screen reading is displayed in the upper left corner of the red box.

FIG. 19 is a block diagram of an apparatus for executing a target program according to an exemplary embodiment of the present disclosure. The apparatus includes:
a display module 1320, configured to display a user interface of a simulator, the simulator being loaded with the target program, and the user interface displaying a program page of the target program;
an enabling module 1340, configured to enable a barrier-free access mode in the simulator, in response to an enabling operation of the barrier-free access mode; and
a barrier-free test module 1360, configured to display design information of barrier-free access on a page element in the program page of the target program in the barrier-free access mode.

In an illustrative embodiment, the design information of the barrier-free access includes: audio information of the barrier-free access. The display module 1320 is configured to display a function bar of the barrier-free access mode on the user interface of the simulator, the function bar including a first trigger control. The barrier-free test module 1360 is configured to display the audio information of the barrier-free access on the page element in the program page of the target program, in response to a trigger operation for the first trigger control.

In an illustrative embodiment, the program page includes at least one page element with the audio information.

The barrier-free test module 1360 is configured to display first annotation boxes on all or part of the page elements in the program page of the target program, in response to the trigger operation on the first trigger control, the audio information of the page elements being displayed on the first annotation boxes.

In an illustrative embodiment, the barrier-free test module 1360 is configured to read ARIA label of each page element in the program page of the target program, in response to the trigger operation on the first trigger control, the ARIA label recording the audio information of the page element; and display the first annotation box on each page element based on the ARIA label of each page element.

In an illustrative embodiment, the design information of the barrier-free access includes: operable area information of the barrier-free access.

The display module 1320 is configured to display a function bar of the barrier-free access mode on the user interface of the simulator, the function bar including a second trigger control. The barrier-free test module 1360 is configured to display the operable area information of the barrier-free access on the page element in the program page of the target program, in response to a trigger operation for the second trigger control.

In an illustrative embodiment, the program page includes at least one page element that supports a human-machine interaction operation.

The barrier-free test module 1360 is configured to display second annotation boxes on all or part of the page elements in the program page of the target program, in response to the trigger operation on the second trigger control, the operable area information of the page elements being displayed on the second annotation boxes.

In an illustrative embodiment, the barrier-free test module 1360 is configured to read each page element bound to an operation element in the program page of the target program, and the operable area information of each page element, in response to the trigger operation on the second trigger control; and display the second annotation box on each page element based on the operable area information of each page element.

In an illustrative embodiment, the display module 1320 is configured to display a function bar of the barrier-free access mode on the user interface of the simulator, the function bar including a first trigger control and a second trigger control.

The barrier-free test module 1360 is configured to display a mixed annotation box on the page element in the program page of the target program in response to a trigger operation for the first trigger control and the second trigger control, the mixed annotation box displaying operable area information and audio information of the barrier-free access.

In an illustrative embodiment, the barrier-free test module 1360 is configured to inject a script in a simulator plug-in into a rendering layer code of the target program to run, in response to an enabling operation of the barrier-free access mode. The simulator plug-in is configured to provide a function of the barrier-free access mode; and re-render the program page of the target program after the script is injected.

In an illustrative embodiment, the target program includes at least one of a web program and a mini program. The mini program is a program depending on running of a host program.

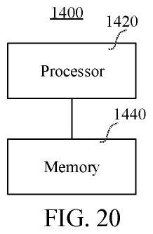

FIG. 20 is a schematic structural diagram of a computer device according to an embodiment of the present disclosure. Typically, the computer device 1400 includes: a processor 1420 and a memory 1440.

The processor 1420 may include one or more processing cores, for example, a 4-core processor or an 8-core processor. The processor 1420 may be implemented in at least one hardware form of a digital signal processor (DSP), a field-programmable gate array (FPGA), and a programmable logic array (PLA). The processor 1420 may further include a main processor and a co-processor. The main processor is a processor configured to process data in an awake state, which may also be called a central processing unit (CPU). The co-processor is a low power consumption processor configured to process the data in a standby state. In some embodiments, the processor 1420 may be integrated with a graphics processing unit (GPU). The GPU is configured to render and draw content that needs to be displayed on a display screen. In some embodiments, the processor 1420 may further include an artificial intelligence (AI) processor. The AI processor is configured to process computing operations related to machine learning.

The memory 1440 may include one or more computer-readable storage media. The computer-readable storage medium may be non-transient. The memory 1440 may further include a high-speed random access memory and a nonvolatile memory, for example, one or more disk storage devices or flash storage devices. In some embodiments, the non-transitory computer-readable storage medium in the memory 1440 is configured to store at least one instruction. The at least one instruction is configured to be executed by the processor 1420 to implement the method for executing a target program according to any of the foregoing method embodiments.

In an exemplary embodiment, a non-transitory computer-readable storage medium is further provided. The computer-readable storage medium stores at least one instruction, at least one segment of a program, a code set, or an instruction set. The at least one instruction, the at least one segment of the program, the code set, or the instruction set is loaded and executed by a processor to implement the method for executing a target program according to any of the foregoing method embodiments.

The present disclosure further provides a non-transitory computer-readable storage medium, storing at least one instruction, at least one program, and a code set or an instruction set, and the at least one instruction, the at least one program, and the code set or the instruction set being loaded and executed by the processor to implement the method for executing a target program according to any of the foregoing method embodiments.

In some embodiments, the present disclosure further provides a computer program product including instructions. The instructions, when being run in a computer device, cause the computer execute the method for executing a target program according to any of the foregoing aspects.

The sequence numbers of the foregoing embodiments of the present disclosure are merely for description purpose but do not imply the preference among the embodiments.

A person of ordinary skill in the art may understand that all or part of the steps of the foregoing embodiments may be implemented by hardware, or may be implemented by a program instructing relevant hardware. The program may be stored in a non-transitory computer-readable storage medium. The storage medium may be a read-only memory, a magnetic disk, an optical disc, or the like. In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit.

The foregoing descriptions are merely embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A method for executing a target program performed by a computer device, the method comprising:
displaying a user interface of a simulator, the user interface including a program page of the target program;
enabling a barrier-free access mode of the target program in the simulator, in response to an enabling operation of the barrier-free access mode; and
displaying information of barrier-free access on a page element in the program page of the target program in the barrier-free access mode.

2. The method according to claim 1, wherein the displaying information of barrier-free access on a page element in the program page of the target program in the barrier-free access mode comprises:
displaying a first trigger control of the barrier-free access mode on the user interface of the simulator; and
displaying audio information of the barrier-free access on the page element in the program page of the target program, in response to a trigger operation for the first trigger control.

3. The method according to claim 2, wherein the program page comprises at least one page element with the audio information; and
the displaying the audio information of the barrier-free access on the page element in the program page of the target program comprises:
displaying first annotation boxes on all or part of the page elements in the program page of the target program, the audio information of the page elements being displayed on the first annotation boxes.

4. The method according to claim 1, wherein the displaying information of barrier-free access on a page element in the program page of the target program in the barrier-free access mode comprises:
displaying a second trigger control of the barrier-free access mode on the user interface of the simulator, the function bar comprising a second trigger control;
displaying operable area information of the barrier-free access on the page element in the program page of the target program, in response to a trigger operation for the second trigger control.

5. The method according to claim 4, wherein the program page comprises at least one page element that supports a human-machine interaction operation; and
the displaying the operable area information of the barrier-free access on the page element in the program page of the target program comprises:
displaying second annotation boxes on all or part of the page elements in the program page of the target program, the operable area information of the page elements being displayed on the second annotation boxes.

6. The method according to claim 1, wherein the displaying information of barrier-free access on a page element in the program page of the target program in the barrier-free access mode comprises:
displaying a first trigger control and a second trigger control of the barrier-free access mode on the user interface of the simulator; and
displaying a mixed annotation box on the page element in the program page of the target program in response to a trigger operation for the first trigger control and the second trigger control, the mixed annotation box including operable area information and audio information of the barrier-free access.

7. The method according to claim 1, wherein the enabling a barrier-free access mode of the target program in the simulator comprises:
injecting a script in a simulator plug-in into a rendering layer code of the target program to run, the simulator plug-in being configured to provide a function of the barrier-free access mode; and
rendering the program page of the target program after the script is injected.

8. A computer device, comprising: a processor and a memory, the memory storing a computer program, and the computer program, when being executed by the processor, causing the computer device to implement a method for executing a target program including:
displaying a user interface of a simulator, the user interface including a program page of the target program;
enabling a barrier-free access mode of the target program in the simulator, in response to an enabling operation of the barrier-free access mode; and
displaying information of barrier-free access on a page element in the program page of the target program in the barrier-free access mode.

9. The computer device according to claim 8, wherein the displaying information of barrier-free access on a page element in the program page of the target program in the barrier-free access mode comprises:
displaying a first trigger control of the barrier-free access mode on the user interface of the simulator; and
displaying audio information of the barrier-free access on the page element in the program page of the target program, in response to a trigger operation for the first trigger control.

10. The computer device according to claim 9, wherein the program page comprises at least one page element with the audio information; and
the displaying the audio information of the barrier-free access on the page element in the program page of the target program comprises:
displaying first annotation boxes on all or part of the page elements in the program page of the target program, the audio information of the page elements being displayed on the first annotation boxes.

11. The computer device according to claim 8, wherein the displaying information of barrier-free access on a page element in the program page of the target program in the barrier-free access mode comprises:
displaying a second trigger control of the barrier-free access mode on the user interface of the simulator, the function bar comprising a second trigger control;
displaying operable area information of the barrier-free access on the page element in the program page of the target program, in response to a trigger operation for the second trigger control.

12. The computer device according to claim 11, wherein the program page comprises at least one page element that supports a human-machine interaction operation; and
the displaying the operable area information of the barrier-free access on the page element in the program page of the target program comprises:
displaying second annotation boxes on all or part of the page elements in the program page of the target program, the operable area information of the page elements being displayed on the second annotation boxes.

13. The computer device according to claim 8, wherein the displaying information of barrier-free access on a page element in the program page of the target program in the barrier-free access mode comprises:
displaying a first trigger control and a second trigger control of the barrier-free access mode on the user interface of the simulator; and
displaying a mixed annotation box on the page element in the program page of the target program in response to a trigger operation for the first trigger control and the second trigger control, the mixed annotation box including operable area information and audio information of the barrier-free access.

14. The computer device according to claim 8, wherein the enabling a barrier-free access mode of the target program in the simulator comprises:
injecting a script in a simulator plug-in into a rendering layer code of the target program to run, the simulator plug-in being configured to provide a function of the barrier-free access mode; and
re-rendering the program page of the target program after the script is injected.

15. A non-transitory computer-readable storage medium, storing a computer program, and the computer program, when being executed by a processor of a computer device, causing the computer device to implement a method for executing a target program including:
displaying a user interface of a simulator, the user interface including a program page of the target program;
enabling a barrier-free access mode of the target program in the simulator, in response to an enabling operation of the barrier-free access mode; and
displaying information of barrier-free access on a page element in the program page of the target program in the barrier-free access mode.

16. The non-transitory computer-readable storage medium according to claim 15, wherein the displaying information of barrier-free access on a page element in the program page of the target program in the barrier-free access mode comprises:
displaying a first trigger control of the barrier-free access mode on the user interface of the simulator; and
displaying audio information of the barrier-free access on the page element in the program page of the target program, in response to a trigger operation for the first trigger control.

17. The non-transitory computer-readable storage medium according to claim 16, wherein the program page comprises at least one page element with the audio information; and
the displaying the audio information of the barrier-free access on the page element in the program page of the target program comprises:
displaying first annotation boxes on all or part of the page elements in the program page of the target program, the audio information of the page elements being displayed on the first annotation boxes.

18. The non-transitory computer-readable storage medium according to claim 15, wherein the displaying information of barrier-free access on a page element in the program page of the target program in the barrier-free access mode comprises:
displaying a second trigger control of the barrier-free access mode on the user interface of the simulator, the function bar comprising a second trigger control;
displaying operable area information of the barrier-free access on the page element in the program page of the target program, in response to a trigger operation for the second trigger control.

19. The non-transitory computer-readable storage medium according to claim 18, wherein the program page comprises at least one page element that supports a human-machine interaction operation; and
the displaying the operable area information of the barrier-free access on the page element in the program page of the target program comprises:
displaying second annotation boxes on all or part of the page elements in the program page of the target program, the operable area information of the page elements being displayed on the second annotation boxes.

20. The non-transitory computer-readable storage medium according to claim 15, wherein the enabling a barrier-free access mode of the target program in the simulator comprises:
injecting a script in a simulator plug-in into a rendering layer code of the target program to run, the simulator plug-in being configured to provide a function of the barrier-free access mode; and
re-rendering the program page of the target program after the script is injected.
